(19) United States
(12) Patent Application Publication
(10) Pub. No.: US 2023/0299331 A1
(43) Pub. Date: Sep. 21, 2023

(54) SECONDARY BATTERY

(71) Applicant: TOYOTA JIDOSHA KABUSHIKI KAISHA, Toyota-shi (JP)

(72) Inventor: Keisuke MORITA, Susono-shi (JP)

(21) Appl. No.: 18/154,080

(22) Filed: Jan. 13, 2023

(30) Foreign Application Priority Data
Mar. 18, 2022 (JP) 20222-044613

(51) Int. Cl. H01M 10/0525; H01M 4/66; H01M 4/131; H01M 4/136

(52) U.S. Cl. CPC H01M 10/0525; H01M 4/661; H01M 4/131; H01M 4/136

(57) ABSTRACT

A secondary battery includes a positive electrode, an electrolyte layer, a negative electrode current collector, and metallic lithium as a negative electrode active material that is deposited between the electrolyte layer and the negative electrode current collector by charging, wherein a nitride of an element M is present between the electrolyte layer and the negative electrode current collector, wherein the element M is an element that is able to be alloyed with Li, and wherein the nitride is covalent.

### CROSS-REFERENCE TO RELATED APPLICATION

This application claims priority to Japanese Patent Application No. 2022-044613 filed on Mar. 18, 2022, incorporated herein by reference in its entirety.

### BACKGROUND

### 1. Technical Field

The present disclosure discloses a secondary battery.

### 2. Description of Related Art

Japanese Unexamined Patent Application Publication No. 2016-012495 (JP 2016-012495 A) discloses a lithium solid secondary battery including a positive electrode, a solid electrolyte layer, a negative electrode current collector, and metallic lithium as a negative electrode active material deposited between the solid electrolyte layer and the negative electrode current collector by charging. U.S. Patent Application Publication No. 2017/0346099 discloses a lithium battery including a negative electrode containing lithium metal or a lithium alloy, an ionically conductive amorphous metal nitride layer disposed on the surface of the negative electrode, an electrolytic solution, and a positive electrode.

### SUMMARY

According to the findings by the inventors, the secondary battery including a deposition type metallic lithium negative electrode disclosed in JP 2016-012495 A has a problem of the Coulomb efficiency of metallic lithium deposition and dissolution reactions being low when the metallic lithium is repeatedly deposited and dissolved between the electrolyte layer and the negative electrode current collector.

In order to address the above problem, one aspect of the present disclosure provides a secondary battery including a positive electrode, an electrolyte layer, a negative electrode current collector, and metallic lithium as a negative electrode active material that is deposited between the electrolyte layer and the negative electrode current collector by charging, wherein a nitride of an element M is present between the electrolyte layer and the negative electrode current collector, wherein the element M is an element that is able to be alloyed with Li, and wherein the nitride is covalent.

In the secondary battery of the present disclosure, the nitride may cover at least a part of the surface of the negative electrode current collector.

In the secondary battery of the present disclosure, the positive electrode may contain a lithium-containing oxide as a positive electrode active material.

In the secondary battery of the present disclosure, the electrolyte layer may contain a sulfide solid electrolyte.

The secondary battery of the present disclosure has a high Coulomb efficiency of the metallic lithium deposition and dissolution reactions.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 schematically shows each configuration of a secondary battery 100 after charging and discharging;

FIG. 2A schematically shows an example of a flow of a method of producing a secondary battery;

FIG. 2B schematically shows an example of a flow of a method of producing a secondary battery;

FIG. 2C schematically shows an example of a flow of a method of producing a secondary battery;

FIG. 3 shows cross-sectional SEM and EDX images of a negative electrode after charging in Comparative Example 3;

FIG. 4 shows cross-sectional SEM and EDX images of a negative electrode after charging in Comparative Example 5;

FIG. 5 shows cross-sectional SEM and EDX images of a negative electrode after charging in Example 1; and

FIG. 6 shows changes in XPS spectrums of Si₃N₄ after charging.

### DETAILED DESCRIPTION OF EMBODIMENTS

1. Secondary Battery

FIG. 1 illustrates one embodiment of a secondary battery of the present disclosure. As shown in FIG. 1, a secondary battery 100 according to one embodiment includes a positive electrode 10, an electrolyte layer 20, a negative electrode current collector 31, and metallic lithium 32 as a negative electrode active material deposited between the electrolyte layer 20 and the negative electrode current collector 31 by charging. Here, a nitride 33 of an element M is present between the electrolyte layer 20 and the negative electrode current collector 31. The element M is an element that can be alloyed with Li. The nitride 33 is covalent.

1.1 Positive Electrode

The positive electrode 10 contains at least a positive electrode active material. When the secondary battery 100 is charged, lithium ions released from the positive electrode active material reach between the electrolyte layer 20 and the negative electrode current collector 31 via the electrolyte layer 20, receive electrons and are deposited as metallic lithium. In addition, when the battery is discharged, the metallic lithium 32 between the electrolyte layer 20 and the negative electrode current collector 31 is dissolved (ionized) and returns to the positive electrode 10. The form of the positive electrode 10 may be any form known for the positive electrode of a secondary battery. For example, as shown in FIG. 1, the positive electrode 10 may include a positive electrode current collector 11 and a positive electrode active material layer 12.

1.1.1 Positive Electrode Current Collector

As the positive electrode current collector 11, any collector that is generally used as a positive electrode current collector of secondary batteries can be used. The positive electrode current collector 11 may be a metal foil or metal mesh. In particular, metal foils have excellent handling properties and the like. The positive electrode current collector 11 may be formed of a plurality of metal foils. Examples of metals constituting the positive electrode current collector 11 include Cu, Ni, Cr, Au, Pt, Ag, Al, Fe, Ti, Zn, Co, and stainless steel. In particular, in order to secure oxidation resistance, the positive electrode current collector 11 may contain Al. The positive electrode current collector 11 may have some coating layers on the surface thereof in order to adjust the resistance or the like. In addition, when the positive electrode current collector 11 is formed of a plurality of metal foils, some layers may be provided between the plurality of metal foils. The thickness of the positive electrode current collector 11 is not particularly limited, and may be, for example, 0.1 μm or more or 1 μm or more, and may be 1 mm or less or 100 μm or less.

1.1.2 Positive Electrode Active Material Layer

The positive electrode active material layer 12 contains a positive electrode active material, and may further optionally contain an electrolyte, a conductive aid, a binder and the like. In addition, the positive electrode active material layer 12 may additionally contain various additives. The contents of the positive electrode active material, the electrolyte, the conductive aid and the binder in the positive electrode active material layer 12 may be appropriately determined according to desired battery performance. For example, based on 100 mass % of the entire positive electrode active material layer 12 (total solid content), the content of the positive electrode active material may be 40 mass % or more, 50 mass % or more or 60 mass % or more, and may be 100 mass % or less or 90 mass % or less. The shape of the positive electrode active material layer 12 is not particularly limited, and may be, for example, a sheet form having a substantially flat surface. The thickness of the positive electrode active material layer 12 is not particularly limited, and may be, for example, 0.1 m or more, 1 μm or more, 10 μm or more or 30 μm or more, and may be 2 mm or less, 1 mm or less, 500 μm or less or 100 μm or less.

As the positive electrode active material, one known as a positive electrode active material for secondary batteries that can supply lithium to the negative electrode during charging may be used. For example, various lithium-containing oxides such as lithium cobaltate, lithium nickelate, LiNi_{1/3}Co_{1/3}Mn_{1/3}O₂, lithium manganate, and spinel lithium compound can be used as the positive electrode active material. The positive electrode active materials may be used alone or two or more thereof may be used in combination. For example, the positive electrode active material may be in the form of particles, and the size thereof is not particularly limited. The positive electrode active material particles may be solid particles, hollow particles or particles having voids. The positive electrode active material particles may be primary particles or secondary particles in which a plurality of primary particles are aggregated. The average particle size (D50) of the positive electrode active material particles may be, for example, 1 nm or more, 5 nm or more, or 10 nm or more and may be 500 μm or less, 100 μm or less, 50 μm or less, or 30 m or less. Here, the average particle size D50 referred to in the present disclosure is a particle diameter (median diameter) at a cumulative value of 50% in the volume-based particle size distribution obtained by the laser diffraction/scattering method.

The surface of the positive electrode active material may be coated with a protective layer containing an ion-conducting oxide. That is, the positive electrode active material layer 12 may contain a composite including the above positive electrode active material and a protective layer provided on the surface thereof. Thereby, the reaction between the positive electrode active material and sulfide (for example, a sulfide solid electrolyte to be described below) is easily inhibited. Examples of ion-conducting oxides that cover and protect the surface of the positive electrode active material include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, and Li₂WO₄. The coverage (area ratio) of the protective layer with respect to the surface of the positive electrode active material may be, for example, 70% or more, 80% or more, or 90% or more. The thickness of the protective layer may be, for example, 0.1 nm or more or 1 nm or more and may be 100 nm or less or 20 nm or less.

The electrolyte that can be contained in the positive electrode active material layer 12 may be a solid electrolyte, a liquid electrolyte (electrolytic solution), or a combination thereof. In particular, when the positive electrode active material layer 12 contains a solid electrolyte (in particular, a sulfide solid electrolyte), the technology of the present disclosure can be expected to provide an even greater effect.

As the solid electrolyte, those known as solid electrolytes for secondary batteries may be used. The solid electrolyte may be an inorganic solid electrolyte or an organic polymer electrolyte. In particular, the inorganic solid electrolyte has excellent ion conductivity and heat resistance. Examples of inorganic solid electrolytes include oxide solid electrolytes such as lithium lanthanum zirconate, LiPON, Li_{1+X}Al_{X}Ge₂₋ₓ(PO₄)₃, Li—SiO-based glass, and Li—Al—S—O-based glass, and sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂. In particular, the performance of the sulfide solid electrolyte, particularly, a sulfide solid electrolyte containing at least Li, S and P as constituent elements, is high. The solid electrolyte may be amorphous or crystalline. The solid electrolyte may be, for example, in the form of particles. The solid electrolytes may be used alone or two or more thereof may be used in combination.

The electrolytic solution may contain, for example, lithium ions as carrier ions. The electrolytic solution may be, for example, a non-aqueous electrolytic solution. For example, as the electrolytic solution, a solution obtained by dissolving lithium salts at a predetermined concentration in a carbonate solvent can be used. Examples of carbonate solvents include fluoroethylene carbonate (FEC), ethylene carbonate (EC), and dimethyl carbonate (DMC). Examples of lithium salts include hexafluorophosphates.

Examples of conductive aids that can be contained in the positive electrode active material layer 12 include carbon materials such as vapor grown carbon fibers (VGCF), acetylene black (AB), ketjen black (KB), carbon nanotubes (CNT) and carbon nanofibers (CNF); and metal materials such as nickel, aluminum, and stainless steel. The conductive aid may be, for example, in the form of particles or fibers, and the size thereof is not particularly limited. The conductive aids may be used alone or two or more thereof may be used in combination.

Examples of binders that can be contained in the positive electrode active material layer 12 include butadiene rubber (BR)-based binders, butylene rubber (IIR)-based binders, acrylate butadiene rubber (ABR)-based binders, styrene butadiene rubber (SBR)-based binders, polyvinylidene fluoride (PVdF)-based binders, polytetrafluoroethylene (PTFE)-based binders, polyimide (PI)-based binders, and polyacrylic acid binders. The binders may be used alone or two or more thereof may be used in combination.

1.2 Electrolyte Layer

The electrolyte layer 20 contains at least an electrolyte. The electrolyte layer 20 may contain a solid electrolyte, and may further optionally contain a binder, various additives and the like. The contents of the electrolyte, the binder and the like in the electrolyte layer 20 are not particularly limited. The electrolyte layer 20 may contain a liquid component such as an electrolytic solution. The electrolyte layer 20 may have a separator or the like for preventing the positive electrode and the negative electrode from coming into contact with each other, and an electrolytic solution may be retained in the separator. The thickness of the electrolyte layer 20 is not particularly limited, and may be, for example, 0.1 μm or more or 1 μm or more, and may be 2 mm or less or 1 mm or less.

The electrolyte contained in the electrolyte layer 20 may be appropriately selected from among those exemplified as the electrolyte that can be contained in the positive electrode active material layer described above. In particular, when the electrolyte layer 20 contains a solid electrolyte (in particular, a sulfide solid electrolyte), the technology of the present disclosure can be expected to provide an even greater effect. In addition, the binder that can be contained in the electrolyte layer 20 may be appropriately selected from among those exemplified as the binder that can be contained in the positive electrode active material layer described above. The electrolytes and binders may be used alone or two or more thereof may be used in combination. When the secondary battery is an electrolytic solution battery, the separator for retaining the electrolytic solution may be a separator that is commonly used in secondary batteries, and for example, those made of a resin such as polyethylene (PE), polypropylene (PP), polyester and polyamide may be exemplified. The separator may have a single-layer structure or a multi-layer structure. Examples of separators having a multi-layer structure include a separator having a 2-layer structure of PE/PP and a separator having a 3-layer structure of PP/PE/PP or PE/PP/PE. The separator may be made of a non-woven fabric such as a cellulose non-woven fabric, a resin non-woven fabric, and a glass fiber non-woven fabric.

1.3 Negative Electrode Current Collector

As the negative electrode current collector 31, any collector that is generally used as a negative electrode current collector of secondary batteries can be used. The negative electrode current collector 31 may be a metal foil or metal mesh, or a carbon sheet. In particular, metal foils have excellent handling properties and the like. The negative electrode current collector 31 may be formed of a plurality of metal foils or sheets. Examples of metals constituting the negative electrode current collector 31 include Cu, Ni, Cr, Au, Pt, Ag, Al, Fe, Ti, Zn, Co, and stainless steel. In particular, in order to secure reduction resistance and in order to prevent it from alloying with lithium, the negative electrode current collector 31 may contain at least one metal selected from among Cu, Ni and stainless steel. The negative electrode current collector 31 may have some coating layers on the surface thereof. For example, as will be described below, the nitride 33 may cover at least a part of the surface of the negative electrode current collector 31. In addition, when the negative electrode current collector 31 is formed of a plurality of metal foils, some layers may be provided between the plurality of metal foils. The thickness of the negative electrode current collector 31 is not particularly limited, and may be, for example, 0.1 μm or more or 1 μm or more and may be 1 mm or less or 100 μm or less.

1.4 Metallic Lithium as Negative Electrode Active Material

The secondary battery 100 includes a lithium deposition type negative electrode. Specifically, as shown in FIG. 1, the metallic lithium 32 as a negative electrode active material is deposited between the electrolyte layer 20 and the negative electrode current collector 31 by charging. In addition, the metallic lithium 32 deposited between the electrolyte layer 20 and the negative electrode current collector 31 is dissolved (ionized) during discharging and returns to the positive electrode 10.

The amount of the metallic lithium 32 deposited between the electrolyte layer 20 and the negative electrode current collector 31 is not particularly limited, and may be appropriately adjusted according to desired battery performance. However, if the amount of the deposited metallic lithium 32 is too large, there is concern about pressure concentration and the like. In this regard, as a guideline for the amount of the deposited metallic lithium 32, the amount may be such that the charging capacity of the secondary battery 100 is, for example, an amount of 1 mAh/cm² or more and 5 mAh/cm² or less.

According to the findings by the inventors, a conventional secondary battery including a lithium deposition type negative electrode has a problem that, when metallic lithium is repeatedly deposited and dissolved between an electrolyte layer and a negative electrode current collector, the Coulomb efficiency of the deposition and dissolution reaction of metallic lithium is low. According to new findings by the inventors, one cause of this problem is oxidation of deposited metallic lithium. Specifically, when metallic lithium is repeatedly deposited and dissolved, voids and irregularities are generated in metallic lithium due to non-uniform deposition, and the specific surface area of metallic lithium tends to increase. Therefore, when the charging and discharging cycle is repeated, a small amount of oxygen present in the battery reacts with metallic lithium, and the metallic lithium gradually becomes lithium oxide. Lithium oxide is electrochemically inert and cannot be dissolved. Therefore, in conventional secondary batteries, when the charging and discharging cycle is repeated, metallic lithium gradually oxidizes, the amount of active lithium gradually decreases, the Coulomb efficiency decreases, and the battery capacity decreases. In addition, lithium oxide has low electron conductivity and ion conductivity and there is a risk of electrochemical reaction within the battery being inhibited, which may also be a factor in lowering the Coulomb efficiency.

1.5 Nitride

In order to solve the above problem, in the secondary battery 100, when a predetermined nitride 33 is present between the electrolyte layer 20 and the negative electrode current collector 31, oxidation of the metallic lithium 32 deposited between the electrolyte layer 20 and the negative electrode current collector 31 is reduced. Specifically, when the metallic lithium 32 is deposited, the following conversion reaction A is caused between some of the metallic lithium 32 and the nitride 33, and some of the metallic lithium 32 is alloyed and some of the metallic lithium 32 is nitrided. Unlike lithium oxide, lithium nitride has both electron conductivity and lithium ion conductivity so that it does not inhibit the electrochemical reaction. In the following reaction formula, for convenience, it is assumed that Li₃N is produced as lithium nitride, but actually, the composition ratio of Li and N is considered to be indefinite, and N is dispersed in a wide range of the metallic lithium 32 deposited between the electrolyte layer 20 and the negative electrode current collector 31, and it is considered that it becomes difficult for the metallic lithium 32 as a whole to be oxidized.

MₓN_{y}+zLi⁺+ze⁻→Li_{(z-3y)}Mₓ+yLi₃N (Reaction A)

When some of the metallic lithium 32 deposited between the electrolyte layer 20 and the negative electrode current collector 31 is alloyed, and some is nitrided, the reactivity between the metallic lithium 32 and oxygen decreases, and the production of lithium oxide is reduced. In addition, even if alloyed lithium and nitrided lithium have better electron conductivity and ion conductivity than lithium oxide, and remain between the electrolyte layer 20 and the negative electrode current collector 31 when the secondary battery 100 is charged and discharged, it is difficult to inhibit the electrochemical reaction in the secondary battery 100. Therefore, the secondary battery 100 in which a predetermined nitride 33 is present between the electrolyte layer 20 and the negative electrode current collector 31 has a higher Coulomb efficiency than in a case in which a predetermined nitride 33 is not present between the electrolyte layer 20 and the negative electrode current collector 31 (in the related art).

Here, in the secondary battery 100, it is necessary for the nitride 33 to satisfy the following requirements (1) and (2).
(1) The element M constituting the nitride 33 is an element that can be alloyed with Li.
(2) The nitride 33 is covalent.

Regarding the requirement (1), if the element M is not alloyed with lithium, the conversion reaction A does not occur. Whether the element M is an element that is alloyed with lithium may be determined from a known database (phase diagram) or the like.

Regarding the requirement (2), if the nitride 33 is non-covalent (for example, when it is ionic-bonding), it is difficult to dissociate the element M and nitrogen N in the nitride 33, and the conversion reaction A is difficult to proceed. In addition, the non-covalent nitride tends to have lower electron conductivity than the covalent nitride 33, and in this point, it is considered that the conversion reaction A is less likely to occur. Whether the nitride 33 is covalent may be determined according to the difference in Pauling's electronegativity between the element M and the nitrogen N. That is, when the difference in Pauling's electronegativity between the element M and the nitrogen N constituting the nitride is smaller, the nitride tends to be covalent. For example, the difference between Pauling's electronegativity of the element M and Pauling's electronegativity of the nitrogen N may be 1.2 or less.

According to the nitride 33 of the element M that satisfies both the above requirements (1) and (2), the above conversion reaction A can be caused efficiently. Examples of such an element M include at least one element selected from among Si, Ga, Sn, and In. Particularly, when at least one of Si and Ga, specifically, Si is used as the element M, a strong effect is easily obtained.

In the secondary battery 100, the form of the nitride 33 is not particularly limited, and various forms in which the conversion reaction A can proceed may be used. For example, the nitride 33 may be layered. In addition, the nitride 33 may cover at least a part of the surface of the negative electrode current collector 31. Specifically, a layer (film) of the nitride 33 may be laminated on at least a part of the surface of the negative electrode current collector 31. In this case, the thickness of the layer (film) of the nitride 33 is not particularly limited. According to the thickness of the layer (film), the amount of the product produced by the conversion reaction A can be controlled. According to the amount of the deposited metallic lithium 32 in the secondary battery 100 or the like, the thickness of the layer (film) may be determined. For example, the thickness of the layer (film) may be 10 nm or more and 10 μm or less. Here, when the layer (film) is too thick, metallic lithium is excessively alloyed and nitrided, resulting in an excessive decrease in the amount of electrochemically active lithium.

1.6 Other Members

The secondary battery 100 may have at least the above configuration, and may include other members. The members described below are examples of other members that the secondary battery 100 may have.

1.6.1 Exterior Body

The secondary battery 100 may be a battery in which each of the above configurations is accommodated inside an exterior body. More specifically, a part excluding tabs, terminals and the like for extracting power from the secondary battery 100 to the outside may be accommodated inside the exterior body. As the exterior body, any one known as an exterior body for a battery can be used. For example, a laminate film may be used as the exterior body. In addition, a plurality of secondary batteries 100 may be electrically connected and arbitrarily stacked to form an assembled battery. In this case, the assembled battery may be accommodated inside a known battery case.

1.6.2 Sealing Resin

In the secondary battery 100, each of the above configurations may be sealed with a resin. For example, at least a side surface (surface in the lamination direction) of each layer shown in FIG. 1 may be sealed with a resin. This makes it easier to prevent water from entering the interior of each layer. As the sealing resin, a known curable resin or thermoplastic resin may be used.

1.6.3 Restraining Member

The secondary battery 100 may or may not include a restraining member for restraining each of the above configurations in the thickness direction. When a restraining pressure is applied by the restraining member, the internal resistance of the battery is likely to be reduced. There is no particular limitation on the restraining pressure of the restraining member.

2. Negative Electrode Current Collector for Lithium Deposition Type Negative Electrode

The technology of the present disclosure also includes an aspect of a negative electrode current collector for a lithium deposition type negative electrode. That is, in the negative electrode current collector for a lithium deposition type negative electrode of the present disclosure, at least a part of the surface is coated with the nitride of an element M, the element M is an element that can be alloyed with Li, and the nitride is covalent. As described above, when the surface of the negative electrode current collector 31 is coated with the nitride 33, the conversion reaction A occurs between the metallic lithium 32 and the nitride 33 when the metallic lithium 32 is deposited, some of the metallic lithium 32 is alloyed, some is nitrided, and the metallic lithium 32 is unlikely to be oxidized. The method for coating the surface of the negative electrode current collector 31 with the nitride 33 is not particularly limited. For example, the nitride 33 may be deposited and laminated on the surface of the negative electrode current collector 31 by sputtering using the nitride 33 as a target. In this case, a layer of the nitride 33 having a desired thickness can be formed on the surface of the negative electrode current collector 31 by adjusting a sputtering time or the like.

3. Method of Producing Secondary Battery

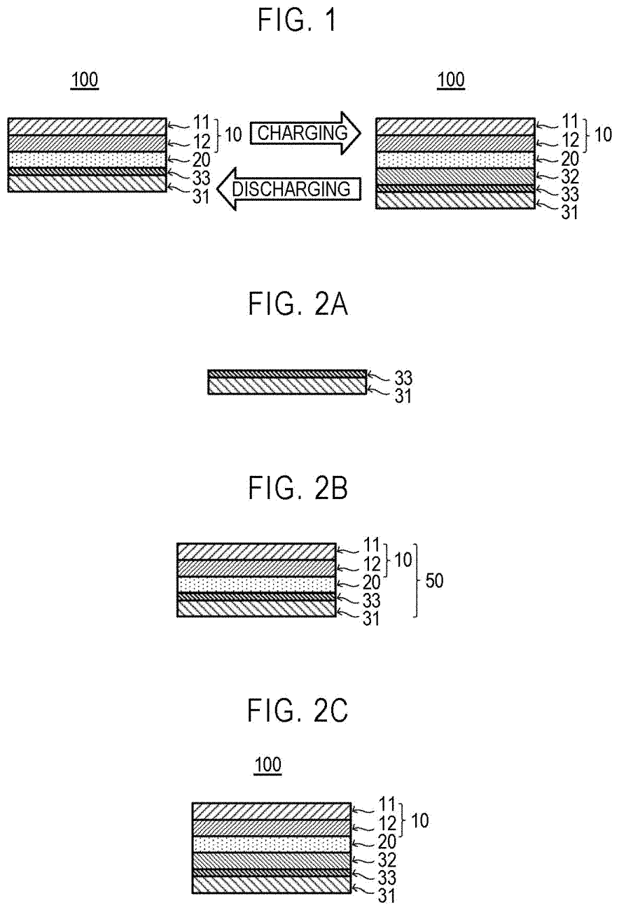

The secondary battery 100 can be produced, for example, as follows. That is, as shown in FIG. 2A, FIG. 2B, and FIG. 2C, a method of producing the secondary battery 100 according to one embodiment includes coating at least one surface of the surface of the negative electrode current collector 31 and the surface of the electrolyte layer 20 with a nitride 33 (FIG. 2A),
obtaining a laminate 50 including the positive electrode 10, the electrolyte layer 20, the nitride 33 and the negative electrode current collector 31 in this order using the negative electrode current collector 31 or the electrolyte layer 20 coated with the nitride 33 (FIG. 2B), and
charging the laminate 50, depositing the metallic lithium 32 between the electrolyte layer 20 and the negative electrode current collector 31, and reacting the metallic lithium 32 with the nitride 33 (FIG. 2C).

3.1 Coating with Nitride

As shown in FIG. 2A, in the production method according to the present embodiment, at least one surface of the surface of the negative electrode current collector 31 and the surface of the electrolyte layer 20 is coated with the nitride 33. In consideration of excellent handling properties or the like, as shown in FIG. 2A, the surface of the negative electrode current collector 31 may be coated with the nitride 33. The method for coating the surface of the negative electrode current collector 31 or the surface of the electrolyte layer 20 with the nitride 33 is not particularly limited. For example, as described above, sputtering may be used.

3.2 Production of Laminate

As shown in FIG. 2B, in the production method according to the present embodiment, the laminate 50 including the positive electrode 10, the electrolyte layer 20, the nitride 33 and the negative electrode current collector 31 in this order is obtained using the negative electrode current collector 31 or the electrolyte layer 20 coated with the nitride 33 as described above. For example, the laminate 50 is easily obtained by performing molding and laminating by applying and transferring the above materials so that the positive electrode current collector 11, the positive electrode active material layer 12, the electrolyte layer 20, the nitride 33 and the negative electrode current collector 31 described above are laminated in this order. The laminate 50 may include at least one of each of the positive electrode current collector 11, the positive electrode active material layer 12, the electrolyte layer 20, the nitride 33 and the negative electrode current collector 31. That is, the laminate 50 may include at least one lamination unit of the positive electrode current collector 11, the positive electrode active material layer 12, the electrolyte layer 20, the nitride 33 and the negative electrode current collector 31 described above, and may include a plurality of lamination units. In this case, the plurality of lamination units may be electrically connected in series or parallel to each other or may not be electrically connected.

After the laminate 50 is obtained, pressure may be applied to the laminate 50 in the thickness direction (lamination direction). For example, the layers constituting the laminate 50 may be integrated by pressing or gaps between the layers constituting the laminate 50 may be eliminated and the interfacial resistance may be reduced. The laminate 50 may be pressed by a known technique. For example, the laminate 50 can be pressed in the lamination direction by various pressing methods such as CIP, HIP, roll pressing, uniaxial pressing, and mold pressing. The magnitude of the pressure applied to the laminate 50 in the lamination direction may be appropriately determined according to desired battery performance. For example, when the laminate 50 contains a sulfide solid electrolyte, in order to plastically deform the sulfide solid electrolyte and easily perform the above integration and elimination of gaps, the pressure may be 100 MPa or more, 150 MPa or more, 200 MPa or more, 250 MPa or more, 300 MPa or more or 350 MPa or more. The pressurization time and pressurization temperature of the laminate 50 are not particularly limited.

3.3 Charging

As shown in FIG. 2C, in the production method according to the present embodiment, the obtained laminate 50 is charged as described above, and the metallic lithium 32 is deposited between the electrolyte layer 20 and the negative electrode current collector 31. Specifically, when the laminate 50 is charged, lithium ions move from the positive electrode active material contained in the positive electrode active material layer 12 toward the negative electrode current collector 31 via the electrolyte layer 20, the lithium ions receive electrons between the electrolyte layer 20 and the negative electrode current collector 31 and are deposited as the metallic lithium 32. In this case, some of the metallic lithium 32 reacts with the nitride 33, some may be alloyed and some may be nitrided. Thereby, the metallic lithium 32 as a whole is unlikely to be oxidized. Charging may be the first charging after the laminate 50 is prepared or may be second or subsequent charging. The laminate 50 may be charged by the same method as the method of charging a general battery. That is, charging may be performed by connecting an external power supply to the positive electrode current collector 11 and the negative electrode current collector 31 of the laminate 50.

3.4 Other Processes

The production method according to the present embodiment may include a general process for producing a secondary battery in addition the above processes. For example, a process of accommodating the laminate 50 inside an exterior body such as a laminate film and a process of connecting a current collection tab to the laminate 50 may be used. Specifically, for example, while a current collection tab is connected to the current collectors 11 and 31 of the laminate 50 (a part of the current collectors 11 and 31 may be protruded and used as a tab), and the laminate 50 is then accommodated in a laminate film as an exterior body with the tab pulled out to the outside of the laminate film, the laminate film is sealed, and then the laminate 50 may be charged through the tab outside the laminate film.

4. Supplement

As described above, in the secondary battery including a lithium deposition type negative electrode, if a predetermined nitride is disposed between the electrolyte layer and the negative electrode current collector, when metallic lithium is deposited between the electrolyte layer and the negative electrode current collector when the battery is charged, some the metallic lithium is alloyed, some is nitrided, and the metallic lithium is unlikely to be oxidized. Therefore, the reaction between oxygen present in the battery and metallic lithium is inhibited, lithium oxide is unlikely to be generated, and the Coulomb efficiency related to deposition and dissolution of metallic lithium is improved. Here, examples of oxygen present in the battery include oxygen derived from the battery materials and oxygen that enters the battery from the outside of the battery. For example, when the positive electrode active material is a lithium-containing oxide, oxygen may be released from the lithium-containing oxide. In the secondary battery of the present disclosure, when the positive electrode contains a lithium-containing oxide as a positive electrode active material, even if a small amount of oxygen is released from the lithium-containing oxide and reaches metallic lithium on the side of the negative electrode, the reaction between the oxygen and the metallic lithium can be inhibited.

As described above, metallic lithium deposited between the electrolyte layer and the negative electrode current collector tends to have higher reactivity with respect to oxygen as the specific surface area increases due to gaps and irregularities. Gaps and irregularities in metallic lithium are likely to occur due to non-uniform deposition of metallic lithium between the electrolyte layer and the negative electrode current collector. Here, non-uniform deposition of metallic lithium tends to occur when the electrolyte layer contains a solid electrolyte (in particular, a sulfide solid electrolyte). This is because, between the solid electrolyte and the negative electrode current collector, point contact between the battery materials and local pressure concentration occur, and the uneven reaction is likely to occur. In the secondary battery of the present disclosure, when the electrolyte layer contains a solid electrolyte (in particular, a sulfide solid electrolyte), even if metallic lithium is non-uniformly deposited between the electrolyte layer and the negative electrode current collector, it is possible to reduce oxidation of metallic lithium.

One embodiment of the technology of the present disclosure has been described above, but the technology of the present disclosure can be modified into embodiments other than the above embodiment without departing from the spirit and scope of the present disclosure. Hereinafter, the technology of the present disclosure will be described in more detail with reference to examples, but the technology of the present disclosure is not limited to the following examples. Here, in the following examples, when a solid electrolyte, an active material, and a conductive aid are handled, the operation was performed in an Ar gas atmosphere and in a glove box of which the dew point is adjusted to −70° C. or lower.

1. Production of Evaluation Cell 100 mg of a sulfide glass solid electrolyte containing Li, P and S was weighed out, put into a φ11.28 mm cylindrical cylinder, and press-molded at 6 ton to produce an electrolyte pellet. A metallic lithium foil (with a thickness of 150 m) was disposed on one surface of an electrolyte pellet, various collector foils to be described below were disposed on the other surface, and pressing was performed at 1 ton to obtain a laminate. The obtained laminate was restrained at 1 MPa to obtain an evaluation cell.

### 1.1 Comparative Example 1

An SUS304 foil (with a thickness of 10 m, the same applies hereinafter) was used as the collector foil.

### 1.2 Comparative Example 2

An SUS304 foil coated with boron nitride (BN) was used as the collector foil. BN coating was performed by sputtering to form a BN layer having a thickness of 1,000 nm on the surface of the SUS304 foil.

### 1.3 Comparative Example 3

An SUS304 foil coated with copper nitride (Cu₃N) was used as the collector foil. Cu₃N coating was performed by sputtering to form a Cu₃N layer having a thickness of 1,000 nm on the surface of the SUS304 foil.

### 1.4 Comparative Example 4

An SUS304 foil coated with magnesium nitride (Mg₃N₂) was used as the collector foil. Mg₃N₂ coating was performed by sputtering to form a Mg₃N₂ layer having a thickness of 1,000 nm on the surface of the SUS304 foil.

### 1.5 Comparative Example 5

An SUS304 foil coated with aluminum nitride (AlN) was used as the collector foil. AlN coating was performed by sputtering to form an AlN layer having a thickness of 1,000 nm on the surface of the SUS304 foil.

### 1.6 Example 1

An SUS304 foil coated with silicon nitride (Si₃N₄) was used as the collector foil. Si₃N₄ coating was performed by sputtering to form a Si₃N₄ layer having a thickness of 1,000 nm on the surface of the SUS304 foil.

2. Charging and Discharging Cycle Test

The produced evaluation cell was connected to a charging and discharging test machine, and the cycle test was performed at +1 V to −1 V, 0.435 mA/cm² while the temperature was maintained at 60° C. The number of cycles was 50. The Coulomb efficiency was calculated as a ratio of the discharging capacity to the charging capacity in each cycle. An average value of Coulomb efficiencies after 10 and subsequent cycles in which the charging and discharging reaction was stabilized was found.

3. Results

The following Table 1 shows properties nitrides on the surface of the collector foil and the charging and discharging cycle test results.

TABLE 1

| | | | | Whether | |
|---|---|---|---|---|---|
| | | Difference | | element M | |
| | | in electro- | | and Li can | |
| | | negativity | | be alloyed | |
| | | between | | (can be | |
| | | element | | alloyed: A | Coulomb |
| | Nitride | M and | Type of | cannot be | efficiency |
| | MₓN_{y} | N | bond | alloyed: B) | (%) |
| Comparative | None | — | — | — | 96.4 |
| Example 1 | | | | | |
| Comparative | BN | 1.00 | Covalent | B | 96.2 |
| Example 2 | | | | | |
| Comparative | Cu₃N | 1.14 | Covalent | B | 92.5 |
| Example 3 | | | | | |
| Comparative | Mg₃N₂ | 1.73 | Ionic | A | 91.7 |
| Example 4 | | | | | |
| Comparative | AlN | 1.43 | Ionic | A | 94.9 |
| Example 5 | | | | | |
| Example 1 | Si₃N₄ | 1.14 | Covalent | A | 99.3 |

As can be clearly understood from the results shown in Table 1, it was found that the Coulomb efficiency of the evaluation cell changed largely depending on the type of nitride MₓN_{y} present between the electrolyte pellet and the current collector (SUS304). As shown in Table 1, when the element M constituting the nitride could not be alloyed with Li (Comparative Examples 2 and 3), and when the nitride was ionic-bonding (Comparative Examples 4 and 5), the Coulomb efficiency was poorer than when no nitride was present (Comparative Example 1). On the other hand, when the element M constituting the nitride was an element that could be alloyed with Li and the nitride was covalent (Example 1), the Coulomb efficiency was significantly improved compared to when no nitride was present (Comparative Example 1).

When metallic lithium was deposited on the surface of the nitride of the element M, the following conversion reaction A could occur thermodynamically.

MₓN_{y}+zLi⁺+ze⁻→Li_{(z-3y)}Mₓ+yLi₃N (Reaction

As shown in Table 1, it is considered that, among various nitrides, when (1) the element M constituting the nitride was an element that could be alloyed with Li, and (2) the nitride was covalent, the above reaction A proceeded. A more detailed consideration is as follows.

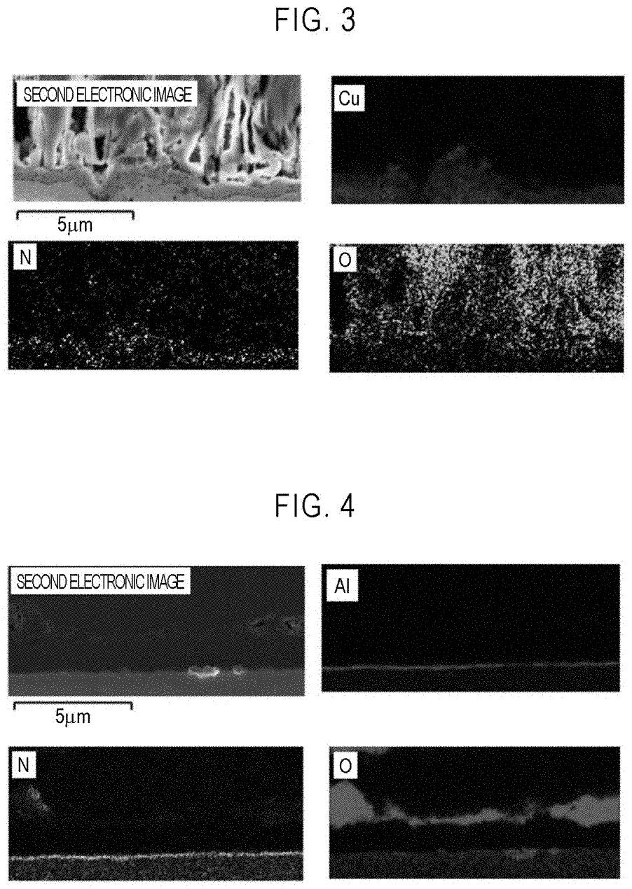

FIG. 3 shows cross-sectional SEM and EDX images of the negative electrode after charging in Comparative Example 3 (in the presence of Cu₃N). As shown in FIG. 3, it was found that, neither Cu nor N diffused from the surface of the collector foil and the conversion reaction A with metallic lithium did not occur. It was considered that, although Cu₃N was covalent, the conversion reaction A did not occur because Cu and Li were not alloyed. In Comparative Example 3, it was considered that oxygen in the system reacted with metallic lithium to generate lithium oxide, and the Coulomb efficiency decreased.

FIG. 4 shows cross-sectional SEM and EDX images of the negative electrode after charging in Comparative Example 5 (in the presence of AlN). As shown in FIG. 4, it was found that neither Al nor N diffused from the surface of the collector foil and the conversion reaction A with metallic lithium did not occur. It was considered that, although Al was alloyed with Li, dissociation of Al—N bonds was unlikely to occur and the conversion reaction did not proceed because AlN was ionic-bonding. In Comparative Example 5, as in Comparative Example 3, it was considered that oxygen in the system reacted with metallic lithium to generate lithium oxide, and the Coulomb efficiency decreased.

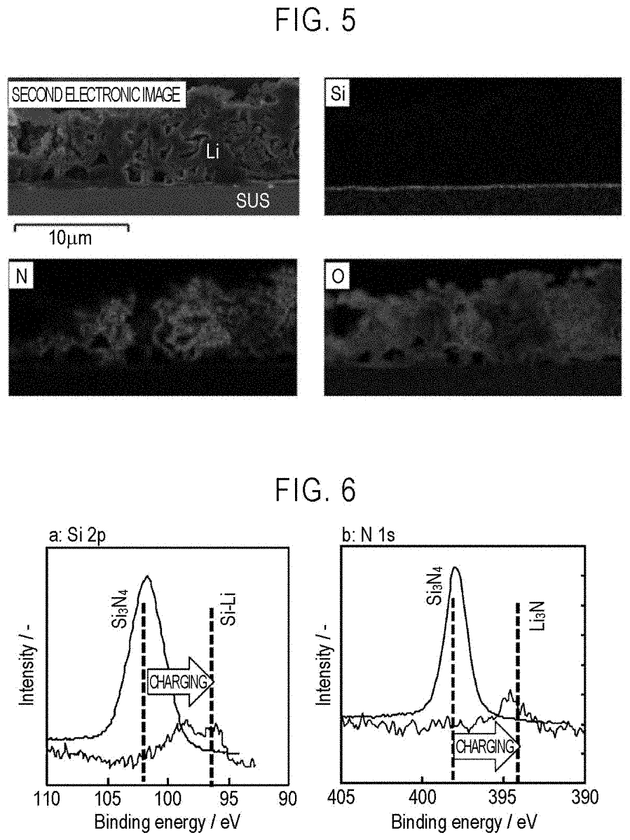

FIG. 5 shows cross-sectional SEM and EDX images of the negative electrode after charging in Example 1 (in the presence of Si₃N₄). As can be clearly understood from FIG. 5, it was assumed that N diffused into Li, and the conversion reaction A proceeded. FIG. 6 shows changes in XPS spectrums of Si₃N₄ after charging. Both Si and N were shifted to the low energy side and reduced, and approached literature data of a Li—Si alloy and Li₃N, respectively. That is, it was found that the conversion reaction A occurred and Si and N were reduced. This was considered to be because Si₃N₄ was covalent, reductive dissociation of Si—N bond was likely to occur, Si could be alloyed with Li and thus the product of the reaction A was stabilized. Some of the metallic lithium was nitrided according to the reaction A. As can be clearly understood from FIG. 5, it was found that nitridation of metallic lithium extended over a wide range of metallic lithium. Accordingly, it was considered that, when some of the metallic lithium was nitrided, the metallic lithium was unlikely to be oxidized. That is, in Example 1, it was considered that oxygen in the system was unlikely to react with metallic lithium, lithium oxide was unlikely to be generated, and thus a high Coulomb efficiency was secured.

Here, while silicon nitride was exemplified as the nitride of the element M in Example 1, the technology of the present disclosure is not limited thereto. As described above, it was considered that, when (1) the element M constituting the nitride was an element that could be alloyed with Li and (2) the nitride was covalent, with the same mechanism as in Example 1, the Coulomb efficiency was improved.

In addition, in Example 1, in order to easily evaluate the Coulomb efficiency, the evaluation cell having a configuration of metallic lithium/electrolyte pellet/(nitride)/collector foil was produced, but this configuration is simply a configuration for simple evaluation, and does not match the configuration of an actual secondary battery. When a secondary battery is actually constructed, a configuration suitable for a secondary battery such as a positive electrode, an electrolyte layer, a nitride and a negative electrode current collector may be used.

What is claimed is:

1. A secondary battery comprising a positive electrode, an electrolyte layer, a negative electrode current collector, and metallic lithium as a negative electrode active material that is deposited between the electrolyte layer and the negative electrode current collector by charging,
wherein a nitride of an element M is present between the electrolyte layer and the negative electrode current collector,
wherein the element M is an element that is able to be alloyed with Li, and
wherein the nitride is covalent.

2. The secondary battery according to claim 1,
wherein the nitride covers at least a part of the surface of the negative electrode current collector.

3. The secondary battery according to claim 1,
wherein the positive electrode contains a lithium-containing oxide as a positive electrode active material.

4. The secondary battery according to claim 1,
wherein the electrolyte layer contains a sulfide solid electrolyte.
